(19) United States
(12) Patent Application Publication
(10) Pub. No.: US 2025/0238109 A1
(43) Pub. Date: Jul. 24, 2025

(54) INTERACTIVE USER ACTIVITY TIMELINE

(71) Applicant: MICROSOFT TECHNOLOGY LICENSING, LLC, Redmond, WA (US)

(72) Inventors: Marisa CANTU, Maple Valley, WA (US); Xiaoli LIU, Sammamish, WA (US); Yan YAN, San Francisco, CA (US); Ryan CUPPERNULL, Ann Arbor, MI (US); Trent Alan HOPPE, Tempe, AZ (US); Bret ANDERSON, Seattle, WA (US); Yohann PURI, Seattle, WA (US); Maxwell XU, Redmond, WA (US); Kenneth Martin TUBBS, Jr., Issaquah, WA (US); Pratik Pankajbhai MISTRI, Bothell, WA (US); Albert Peter YIH, Seattle, WA (US); Jens Erik JORGENSON, Wheaton, IL (US); Yash MISRA, Kirkland, WA (US); Nathan Peter POLLOCK, Woodinville, WA (US)

(21) Appl. No.: 18/420,275

(22) Filed: Jan. 23, 2024

(51) Int. Cl. G06F 3/0481; G06F 9/451

(52) U.S. Cl. CPC G06F 3/0481; G06F 9/451

(57) ABSTRACT

The techniques disclosed herein provide a personalized interactive timeline of user activity graphical user interface (GUI) that enables a personalized search and retrieval user experience. This is accomplished by gathering a record of user activity such as graphical captures (e.g., screenshots) of a desktop environment. A graphical capture can define a software application that is currently in focus within the desktop environment. The graphical captures are then organized into subsets based on the software application that is in focus in each of the graphical captures. The graphical captures are then further organized into sessions which are delineated by substantially continuous user interaction with the corresponding software application. A graphical segment is then generated for each session and subsequently compiled into an interactive timeline. A user can scrub through the timeline to recall previous activity. Moreover, visual analysis can be performed on graphical captures to provide helpful contextual information.

### BACKGROUND

More and more of daily life occurs through computing devices, from completing assignments for work and school to chatting with friends and family. As such, a user may utilize a diverse array of software applications to accomplish various tasks. Moreover, a given software application can be transformed by different contexts. For instance, an internet browser can be utilized to look up nearby restaurants at one moment and research information for a presentation at another moment. Consequently, the user may lose track of what they were working on as well as the context of that work. To aid users in retracing their steps, many software applications include features for searching and retrieving content and/or activity, such as the browsing history in an internet browser and a listing of recent files in a file explorer.

However, existing features such as keyword-based searches, folder hierarchies, and app-specific organization tools may lack the ability to record context and decipher user intent. For example, a user may attempt a keyword search to recover a source of information for citation in a presentation. Unfortunately, the lack of specificity in existing approaches may prevent the user from finding the information for which they were looking. Moreover, such features place an additional burden on the user to remember exact details about their past activity such as the name of a website, title of an article, or other information. Manual recollection can be especially challenging due to the sheer amount of information the user generates and interacts with. That is, many existing systems place the onus on the user to spend time manually organizing, categorizing, and documenting information rather than accomplishing the tasks they wish to accomplish.

In addition, even in the event the user is able to return to the app, website, or other object they were searching for, existing systems may nonetheless lack the ability to restore the context of that object. For example, a user may succeed in retrieving a text document through a keyword search and manually navigating a file directory in a file explorer. However, the user may be unable to retrieve the context of the text document such as accompanying software applications that were previously opened. Furthermore, the information the user is searching for may have changed in the intervening time since their most recent access.

It is with respect to these and other considerations that the disclosure made herein is presented.

### SUMMARY

The techniques disclosed herein provide a graphical user interface (GUI) for an interactive user activity timeline that enables a personalized search and retrieval user experience. This is accomplished by gathering, with the consent of the user, a record of user activity such as graphical captures (e.g., screenshots) of a desktop environment. Generally described, a desktop environment is a graphical user interface abstraction of an operating system that enables a user to intuitively interact with software applications on a computing device (e.g., a laptop, a personal computer, a smartphone, a tablet). As such, a graphical capture can define a software application that is currently in focus within the desktop environment. That is, while the user may have multiple software applications open, the user may interact with a single software application, or be determined by the system to interact with the single software application, at a given moment. This software application is accordingly said to be “in focus”.

In various examples, an individual graphical capture is associated with a time of occurrence (e.g., a timestamp) defining when the graphical capture was taken. With reference to the time of occurrence, the present system can retrieve graphical captures spanning a predetermined timeframe (e.g., a day, a week). In addition, the time of occurrence can be utilized for storage and privacy management. For instance, the present system may be configured with a data retention policy in compliance with local privacy regulations (e.g., personal data cannot be stored for more than thirty days). In another example, the user defines a timeframe for the interactive timeline (e.g., a week, a month). Accordingly, the present system retrieves graphical captures having a time of occurrence within the range defined by the timeframe.

Furthermore, the disclosed system can leverage context within the graphical captures to enrich the user experience of the interactive timeline. That is, the disclosed system can analyze the visual information within a given graphical capture to derive context. As described herein, context is the state of the computing device when a graphical capture is created, such as which applications, documents, and websites are open, or what content was filled into a form. In this way, a user can review their activity through the interactive timeline with additional surrounding information to effectively recall their experiences at a given point in time.

Accordingly, a plurality of graphical captures spanning a predetermined timeframe can be processed and organized to generate the interactive timeline. The plurality of graphical captures is divided into subsets according to a software application that is in focus in each of the graphical captures. For example, a graphical capture in which an internet browser is in focus is assigned to the “internet browser” subset. As such, the system generates an “internet browser” subset, a “word processor” subset, a “presentation program” subset, and so forth.

Subsequently, each of the subsets can be further divided into sessions where an individual session is delineated by a period of substantially continuous user interaction with the software application corresponding to the subset. In a specific scenario, a user opens an internet browser to peruse an online store and later switches to a chat application. The period of time from when the user opened the internet browser to when the user switched to the chat application is considered one session. Stated another way, a session can be defined as a period of time from when a software application comes in focus to when the software application goes out of focus. In another example, the user briefly shifts focus (e.g., clicks) from a first software application to a second software application but does not interact with the second software application. That is, the user does not substantively disrupt their interaction with the first software application. Accordingly, the session relating to the first software application is considered substantially continuous while not being strictly continuous.

As such, a given subset can be divided into one or more sessions resulting in multiple sessions across multiple software applications. Moreover, an individual session can comprise one or more graphical captures depending on the amount of user activity within the session. Consequently, graphical captures can be placed within a session according to their time of occurrence such that the sessions are organized chronologically. As mentioned above, each graphical capture may be associated with a time of occurrence defining when the graphical capture was taken thereby enabling the chronological ordering of graphical captures within a session.

At this point, the graphical captures are sufficiently organized to begin constructing the interactive timeline structure. In various examples, the interactive timeline structure is a data structure or other software mechanism defining the appearance and functionality of the interactive timeline. Accordingly, the system generates a graphical segment on the interactive timeline for each session of the multiple sessions. As will be described below, the size of a graphical segment can be calculated in various ways. In one example, the size of the graphical segment is a function of the number of graphical captures within the session (e.g., the level of user activity). In another example, the size of the graphical segment is a function of the amount of time elapsed in the session. Furthermore, each graphical segment can include a color based on the corresponding software application used during the predefined timeframe.

The graphical segments are then compiled into an interactive timeline structure in which the graphical segments are ordered according to time of occurrence. Like the sessions in which individual graphical captures are organized chronologically, the larger interactive timeline structure can likewise order graphical segments chronologically. As such, the time of occurrence for a given session can be defined by the time of occurrence of the first (e.g., the earliest) graphical capture within the session. Stated another way, the time of occurrence for a given session is defined by a graphical capture indicating the beginning of the session. Accordingly, the system renders the interactive timeline structure within the graphical user interface of the desktop environment for user interaction.

The techniques described herein address several technical challenges facing users of modern computing devices (e.g., laptops, personal computers, smartphones, tablets). Foremost among these is organizing and keeping track of the sheer amount of information and content a user generates and interacts with on a daily basis. From chat messages to photos, recipes, slide decks, and text documents, manually recalling past activity, much less the context that informed the user's experience of that activity, can be infeasible. By occasionally taking a graphical capture of the desktop environment and leveraging visual analysis tools, the present system can preserve a “memory” of a user's activity at a given moment while retaining contextual information that can help the user to recall their state of mind at that moment. In this way, the present system introduces enhanced functionality beyond existing search and retrieval tools, such as a browsing history in an internet browser, thereby providing an enriched and engaging user experience.

In another example of the technical benefit of the present disclosure, the disclosed techniques provide improved efficiency for computing devices by reducing the amount of time a user spends recalling information and/or content. By providing an interactive timeline that the user can “scrub” through, the present system enables the user to jump back to a specific point in time. For example, a user may recall that they were working on a presentation at a given point in time. However, the user may not remember what they were specifically working on, such as creating a certain slide, looking up certain information, and so forth. Accordingly, the user can simply select that point in time on the interactive timeline and recall exactly which software applications were open, what information was displayed, and the like. Consequently, the interactive timeline reduces computing resource usage that would have otherwise been expended when searching and returning to the previous state.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates an example desktop environment displaying software applications and an interactive timeline.

FIG. 1B illustrates an example user interaction with the interactive timeline within the example desktop environment.

FIG. 1C illustrates another example user interaction with a timeline filter to customize the display of the interactive timeline.

FIG. 2A illustrates an example user interaction scrubbing to a specific location on the interactive timeline.

FIG. 2B further illustrates the example user interaction selecting the specific location on the interactive timeline to expose additional information.

FIG. 2C further illustrates the example user interaction selecting another location on the interactive timeline to expose additional information.

FIG. 3 illustrates components that enable a restored software application to be recalled via the interactive timeline.

FIG. 4 is a block diagram of a system for organizing graphical captures and generating the interactive timeline.

FIG. 5 is a flow diagram showing aspects of a process for generating an interactive timeline.

FIG. 6 is a computer architecture diagram illustrating an illustrative computer hardware and software architecture for a computing system capable of implementing aspects of the techniques and technologies presented herein.

FIG. 7 is a diagram illustrating a distributed computing environment capable of implementing aspects of the techniques and technologies presented herein.

### DETAILED DESCRIPTION

The techniques disclosed herein provide a graphical user interface (GUI) for a personalized interactive timeline of user activity that enables a personalized search and retrieval user experience. This is accomplished by gathering a record of user activity such as graphical captures (e.g., screenshots) of a desktop environment. An individual graphical capture can define a software application that is currently in focus within the desktop environment at a given time of occurrence (e.g., a timestamp). The graphical captures are then organized into subsets based on the software application that is in focus in each of the graphical captures. The graphical captures can then be further organized into sessions which are delineated by substantially continuous user interaction with the corresponding software application. A graphical segment is then generated for each session and subsequently compiled into an interactive timeline. A user can then scrub through the timeline to recall previous activities. Moreover, visual analysis can be performed on graphical captures to provide relevant contextual information.

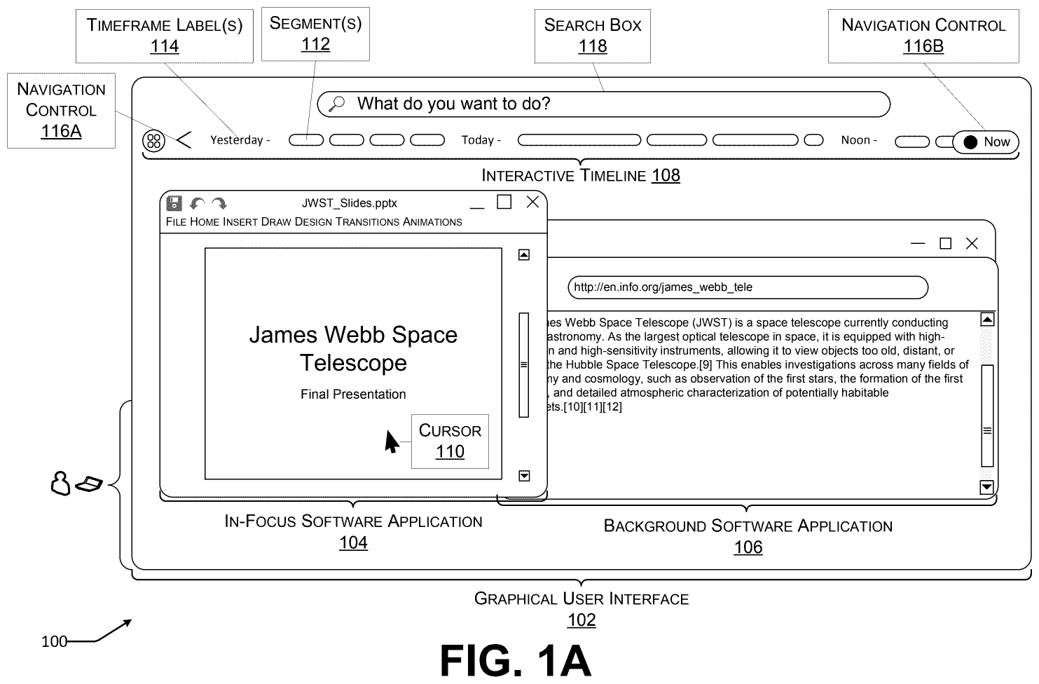

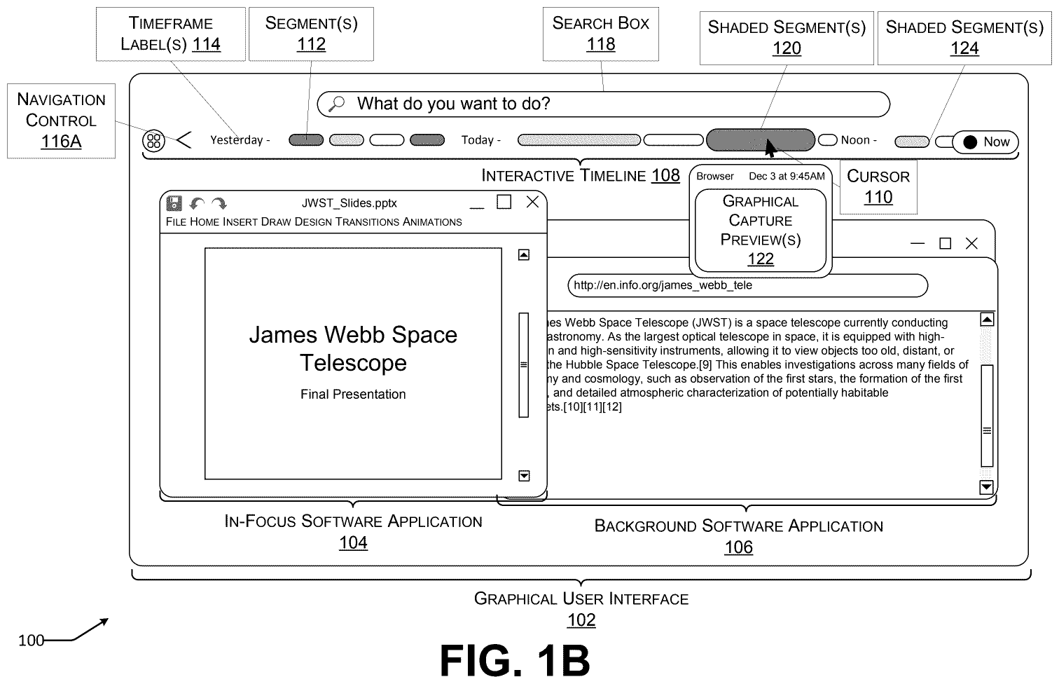

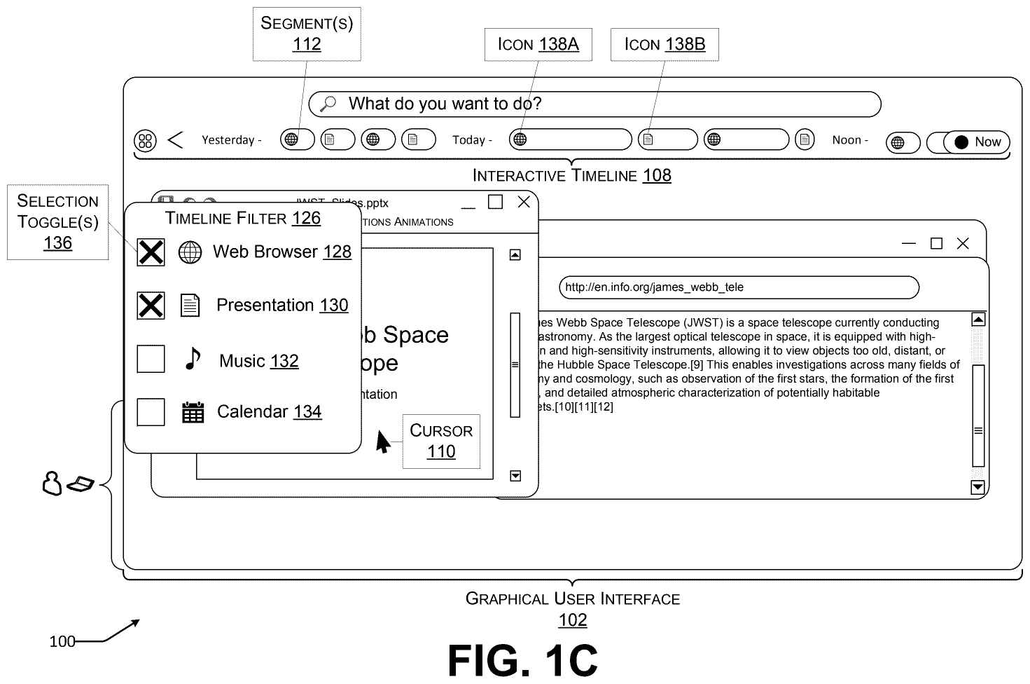

Various examples, scenarios, and aspects that enable an interactive timeline and user experience are described below with respect to FIGS. 1A-7.

FIG. 1A illustrates an example desktop environment 100 displaying a GUI 102 containing an in-focus software application 104 (a presentation program), a background software application 106 (an internet browser) and an interactive timeline 108 in which time progresses from left to right. As mentioned above, a software application is an in-focus software application 104 when a user is currently interacting with the software application. For example, a position of a rendering (e.g., a window) of the software application 104 over renderings of other software applications 106 can indicate which software application is in focus. Likewise, a location of a cursor 110 within the rendering of the software application 104 (e.g., to scroll, to select a user interface element) can indicate which software application is in focus. In another example, the present system determines which software application is currently in focus based on a direction of the eye gaze of the user and/or a voice engagement with an interface of the software application.

In the present example, consider a scenario in which a user is working on a presentation on the James Webb Space Telescope as shown in the in-focus software application 104 and the background software application 106. However, the user realizes that they have forgotten to cite a certain source of information (e.g., a research paper, an encyclopedia entry) for the presentation. Accordingly, the user turns to the interactive timeline 108 to recall the source of information.

As shown in FIG. 1, the interactive timeline 108 includes a set of segments 112 representing user activity sessions across various software applications. That is, an individual segment 112 represents a period of substantially continuous user interaction with a corresponding software application. The segments 112 can be sectioned into units of time by a timeframe label 114. In the present example, the timeframe label 114 divides the interactive timeline 108 into three sections labeled “Yesterday”, “Today”, and “Noon”. In various examples, the timeframe labels 114 can become more granular (e.g., from days to hours) as the timeline progresses closer to the present. In addition, the interactive timeline 108 can be summoned by the user through activating an interface control (e.g., a switch, a button) in the graphical user interface 102, a key or key sequence on an associated keyboard, a particular voice command, or in another suitable manner.

In addition, the size of an individual segment 112 within the interactive timeline 108 can be calculated as a function of a user activity level during a session represented by the individual segment 112. In various examples, the present system can occasionally, e.g., via an operating system component, generate a graphical capture during a user activity session. For instance, the system can be configured to detect a threshold level of change in the graphical user interface 102 and generate a graphical capture in response. Consequently, a session having a high level of user activity results in a correspondingly large number of graphical captures. Conversely, a session with a low level of user activity results in a small number of graphical captures. As such, the size of the resulting segments 112 can be calculated based on the number of graphical captures generated in the associated session. In an alternative example, the size of a segment 112 is calculated based on the amount of elapsed time in the associated session.

In addition, the interactive timeline 108 can include a set of navigation controls 116A and 116B that enable the user to change the timeframe currently displayed by the interactive timeline 108. In one example, the user can utilize the cursor 110 to activate the navigation control 116A to cause the interactive timeline 108 to shift the displayed timeframe. For instance, the interactive timeline 108 of FIG. 1 illustrates segments 112 from yesterday, today, and noon as indicated by the timeframe labels 114. Upon activating the navigation control 116A, the interactive timeline 108 can rewind to an earlier point in time (e.g., two days ago). In response, the section labeled “Noon” scrolls out of view to the right while a new section corresponding to two days ago moves into place from the left. Conversely, the navigation control 116B can be activated to cause the interactive timeline 108 to jump to the present time, likewise resulting in a scrolling motion that fast forwards the interactive timeline 108.

In another example, the user can use a scroll input (e.g., via a mouse, via a touch input, via a keyboard input, via a voice input) to fluidly move the interactive timeline left and right. Accordingly, the segments 112 and timeframe labels 114 can move based on the scroll input. Upon reaching the left or right edge of the interactive timeline 108, the timeframe labels 114 can snap into place and stop moving with the scroll input while the segments 112 associated with the timeframe label 114 can continue to move. That is, the timeframe labels 114 can be configured as “sticky” labels whereupon reaching a predefined position in the graphical user interface 102, the timeframe labels 114 are locked in place and no longer move. In the event the scroll input causes all of the segments 112 for a given section to move out of view (left or right), the timeframe label 114 is likewise removed from view. Finally, the graphical user interface 102 includes a search box 118 that provides an optional modality for a user to perform search and retrieval tasks (e.g., a keyword search).

Turning to FIG. 1B, aspects of an example user interaction with the interactive timeline 108 are shown and described. In the present example, the user can recall that the source of information they seek was accessed at some point in the recent past via a web browser. As shown, the user can provide an input (e.g., mouse, touch) moving the cursor 110 to a position within one of the segments 112 of the interactive timeline 108. In response, the segment 112 at which the cursor 110 is positioned expands in size to indicate the selection and becomes a shaded segment 120. In various examples, the color of the shaded segment 120 can correspond to the software application that is represented by the shaded segment 120. For instance, a software application with a predominantly green color palette for its user interface can result in a green colored shaded segment 120.

Furthermore, different segments 112 that represent the same software application as the shaded segment 120 can also be shaded in the same color. In this way, the user can search through past activity on a software application basis rather than a strictly temporal basis. For example, if the user remembers that they saw an interesting recipe in their internet browser but not necessarily when they saw the recipe, color coding the shaded segments 120 enables the user to quickly find points in time when they were using the internet browser. In various examples, the interactive timeline 108 can be configured to persistently display the colors of the segments 112 rather than selectively shading the segments 112 in response to a user positioning the cursor 110.

In addition, a graphical capture preview 122 can be displayed below the shaded segment 120 at the horizontal location of the cursor 110. In the context of the present disclosure, a graphical capture is a depiction of the current state of the desktop environment 100 at a given time of occurrence. In various examples, the graphical capture preview 122 is a miniaturized version (e.g., a thumbnail image) of the first graphical capture of the session represented by the shaded segment 120. Accordingly, the graphical capture preview 122 can depict a single software application (e.g., the software application that is in focus at that time). In this way, the user can quickly ascertain which software application is represented by the shaded segment 120. Alternatively, the graphical capture preview 122 can depict multiple software applications (e.g., a desktop view). Consequently, as the user moves the cursor 110 between the segments 112 (e.g., scrubs) along the interactive timeline 108 (e.g., via the cursor 110) different graphical capture previews 122 are displayed at the position of the cursor 110.

Furthermore, the interactive timeline 108 can produce additional shaded segments 124 representing the currently in-focus software application 104. In various examples, the color of the additional shaded segments 124 can be different from the color of the shaded segments 120—for instance, if the shaded segments 120 correspond to an internet browser while the additional shaded segments 124 correspond to a presentation program as shown in the in-focus software application 104. Conversely, if the cursor 110 is positioned at one of the shaded segments 124 representing the currently in-focus application 104, the colors are the same. As such, segments 112 that are most relevant to the current context of the user are immediately highlighted by the interactive timeline 108. In various examples, the user may be searching for past sessions of the same in-focus software application 104. By highlighting these segments, the user can spend less time searching and immediately jump to those sessions.

Turning now to FIG. 1C, aspects of a customizable configuration of the interactive timeline 108 are shown and described. In various examples, a user can utilize a timeline filter 126 to configure which software applications are represented by the segments 112 of the interactive timeline 108. As shown, the timeline filter 126 can be a list of software applications such as a web browser 128, a presentation application 130, a music application 132, and a calendar application 134. Furthermore, each software application in the list is accompanied by a selection toggle 136 or other suitable selection mechanism. When a selection toggle 136 is activated, as shown with an “X” marking in FIG. 1C, the corresponding software application 128 and/or 130 is included in the segments 112 of the interactive timeline 108. Conversely, software applications 132 and 134 that are not selected in the timeline filter 126 are not included in the rendering of the interactive timeline 108.

Each of the segments 112 can include an icon 138A or 138B identifying the respective software application 128 or 130 represented by the segment 112. For instance, the web browser 128 is identified by a globe icon 138A while the presentation application 130 is represented by a document icon 138B. In this way, a user can selectively configure the interactive timeline 108 to only show specific software applications. For example, a user may, over the course of a full day, interact with dozens of software applications resulting in many (e.g., hundreds) of individual segments 112. Consequently, rendering all of these segments 112 can reduce the legibility of the interactive timeline 108. As such, by enabling a filter feature via a user selection of a subset of software applications, the timeline filter 126 can reduce visual clutter and improve the user experience.

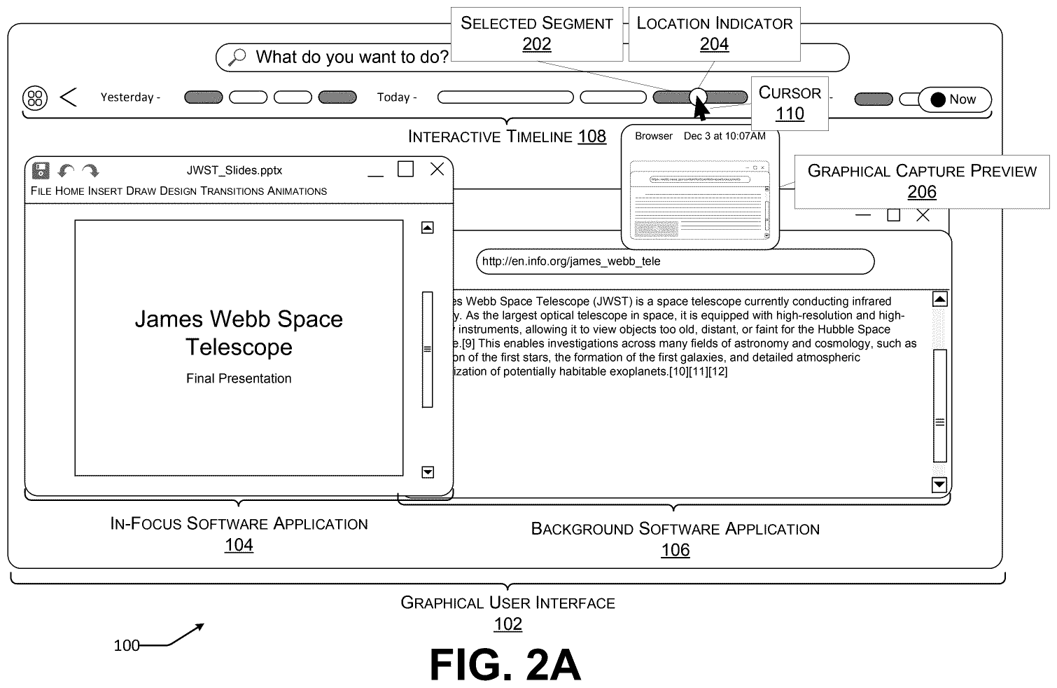

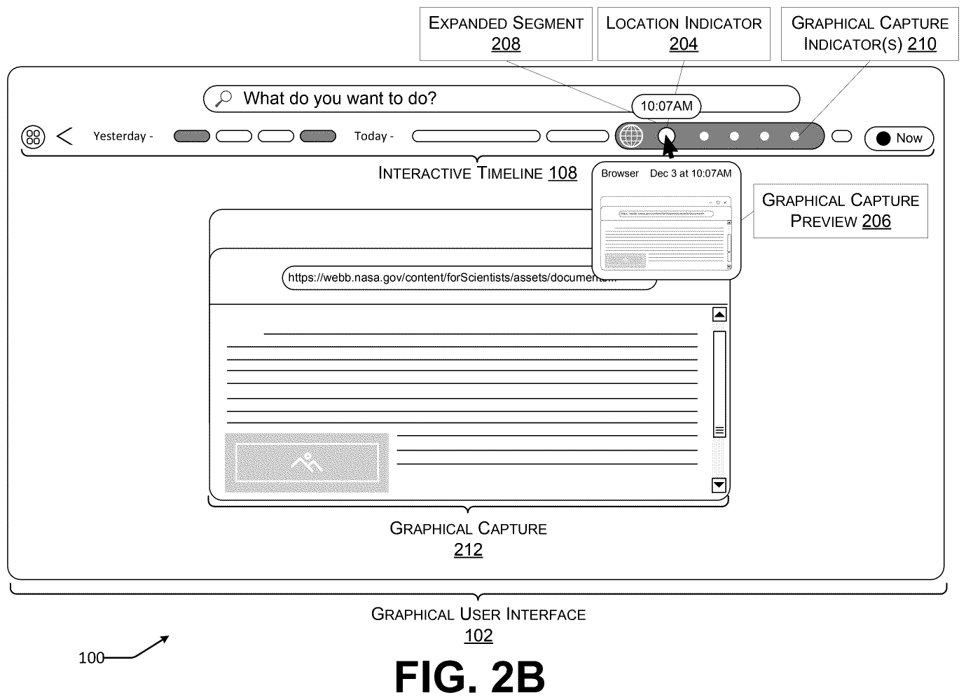

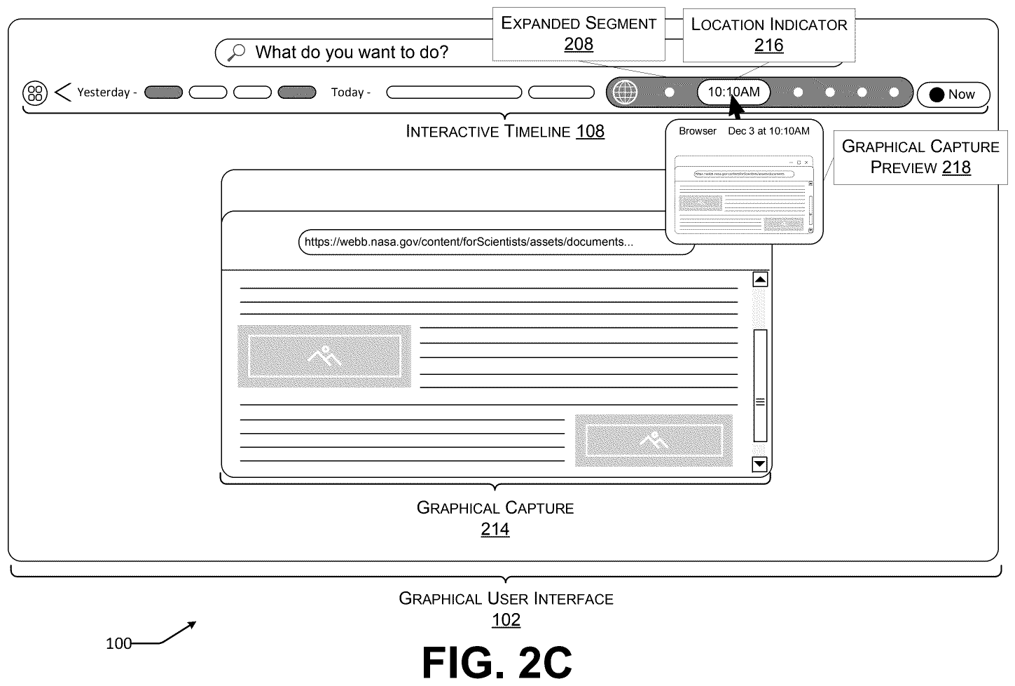

Proceeding to FIG. 2A, a continuation of the example user interaction discussed above is shown and described. As mentioned above, the user recalls accessing the information source in question via the web browser. In the example of FIG. 2A, the user has successfully found the session in which they accessed the specific information. By positioning the cursor 110 within the interactive timeline 108 the user can cause the segments to shade in with the color representing the corresponding software application. That is, the positioning of the cursor 110 can be a first input indicating a selected segment 202. Accordingly, the user can provide a second input (e.g., a click, a tap) confirming the selected segment 202 to enable more granular scrubbing. That is, where the examples discussed above with respect to FIGS. 1A and 1B involve scrubbing between segments 112 of the interactive timeline 108, confirming the selected segment 202 enables the user to scrub within the selected segment 202.

In response to the second input, the interactive timeline 108 generates a location indicator 204 corresponding to the horizontal position of the cursor 110 within the selected segment 202. In addition, a graphical capture preview 206 is displayed concurrently with the location indicator 204 showing a miniaturized version of a graphical capture having a time of occurrence corresponding to the position of the location indicator 204. Moreover, the graphical capture preview 206 can identify the corresponding software application and the time of occurrence. In the present example, the selected segment 202 represents an internet browser software application (“Browser”). Accordingly, the graphical capture preview 206 displays the state of the internet browser at the point in time represented by the location indicator 204 (“Dec 3 at 10:07 AM”).

Turning now to FIG. 2B, the user can provide another user input (e.g., a click, a tap) to transform the previously selected segment 202 into an expanded segment 208 to further increase the scrubbing granularity. As shown, the expanded segment 208 can retain the location indicator 204 and graphical capture preview 206 mentioned above while displaying additional graphical capture indicators 210. In this way, the expanded segment 208 exposes the quantity of graphical captures within the expanded segment 208. Moreover, the graphical user interface 102 is updated to remove or minimize the in-focus software application 104 and the background software application 106 and display a full-size rendering of a graphical capture 212 corresponding to the position of the cursor 110 within the expanded segment 208. In this way, the interactive timeline 108 enables the user to clearly see the information contained in the graphical capture 212 as the user scrubs through the expanded segment 208. In the present example, the graphical capture 212 depicts the article the user wishes to cite for their presentation on the James Webb Space Telescope. However, the user may not have yet found the specific portion of the article they wish to cite.

Proceeding to FIG. 2C, the user can scrub through the expanded segment 208 to view another graphical capture 214 that was taken during the session associated with the expanded segment 208. While the graphical capture 212 discussed above had a time of occurrence of “10:07 AM”, the present graphical capture 214 has a time of occurrence of “10:10 AM” as shown by the updated location indicator 216 and the updated graphical capture preview 218. In various examples, the graphical capture 214 was taken when the user scrolled down the webpage such that a threshold amount of change was detected within the graphical user interface 102. For instance, an operating system component periodically generates and evaluates a contour map of the graphical user interface 102 (e.g., every five seconds). If the operating system component detects a contour map that is sufficiently different (e.g., an eighty percent difference, a seventy percent difference) from a previous contour map, a graphical capture is generated in response.

Moreover, the information that is displayed in the graphical capture 214 can be the same information that was present when the graphical capture 214 was taken. That is, in the event the website depicted by the graphical capture 214 is updated or otherwise modified, the graphical capture 214 preserves the website as it originally appeared. In this way, the user can recall exactly what they previously experienced via the interactive timeline 108. As such, the user can find the specific portion of the article they wish to cite for their presentation.

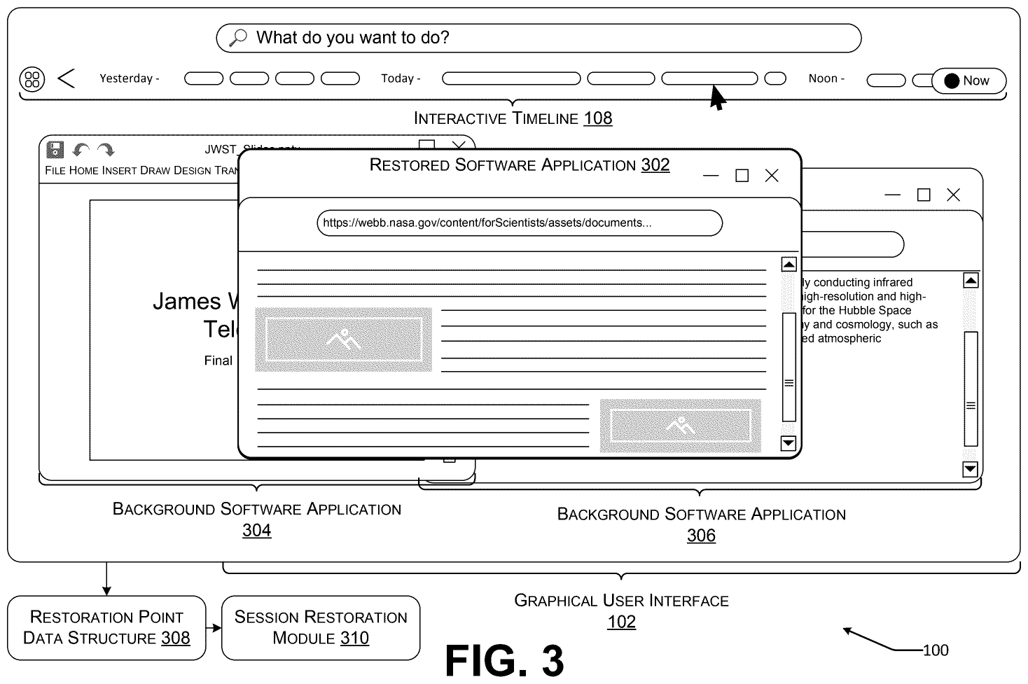

Turning now to FIG. 3, the user can subsequently elect to restore the session represented by the graphical capture 214 shown in FIG. 2C. This can be accomplished by providing a user input within the graphical capture 214 (e.g., a click, a tap). In response, a restored software application 302 is displayed within the graphical user interface 102. Furthermore, the restored software application 302 can return to the same state as defined by the graphical capture 214. In the present example, this state is the position of the webpage within the internet browser. In other examples, the user restores a text document prior to certain edits, returns to a text chat to see what was said at a certain point in time, and so forth. As shown in FIG. 3, the restored software application 302 is now the in-focus software application displaying the specific portion of the article the user wishes to cite for their presentation. Accordingly, presentation program and the existing instance of the web browser are reconfigured as background software application 304 and 306 respectively.

In a specific example, the restored software application 302 is recalled via a restoration point data structure 308 by a standalone session restoration module 310. That is, the session restoration module 310 may be a different software service and/or component from that which provides the interactive timeline 108. As such, when the user elects to restore the session represented by the graphical capture 214, a restoration point data structure 308 is generated to enable the recollection of the restored software application 302 by the session restoration module 310. In various examples, the restoration point data structure 308 includes data defining a time of occurrence and a software application session associated with the graphical capture 214. However, it should be understood that the restoration point data structure can include any necessary data to enable restoring a past software application session.

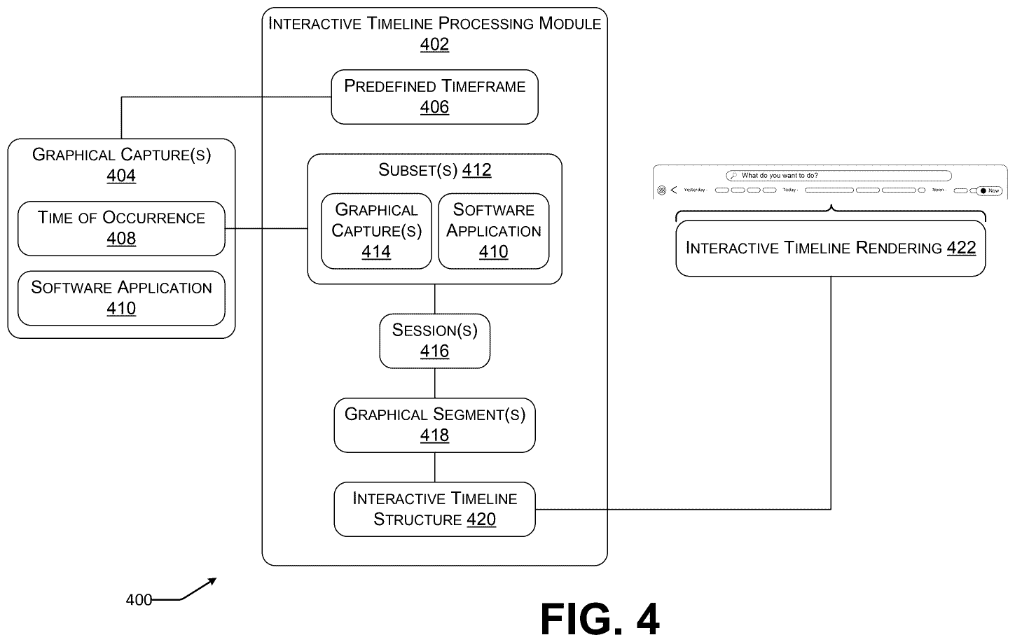

Turning now to FIG. 4, aspects of a system 400 that enables the interactive timeline 108 discussed above are shown and described. Generally described, the functions of the interactive timeline can be performed by an interactive timeline processing module 402. In various examples, the interactive timeline processing module 402 can be a software component of an operating system having access to a record of user activity (e.g., graphical captures). As such, the interactive timeline processing module 402 can retrieve a set of graphical captures 404 spanning a predetermined timeframe 406 (e.g., a day, a week). Each of the graphical captures 404 includes a time of occurrence 408 (e.g., a timestamp) defining a date and time at which the graphical capture 404 was generated. In addition, the graphical capture 404 can define a software application 410 that was in focus at the time of occurrence 408.

The interactive timeline processing module 402 can subsequently organize the graphical captures 404 into subsets 412 according to the software application 410 of each graphical capture 404. For example, the interactive timeline processing module 402 can generate an internet browser subset, a word processer subset, a chat application subset, and so forth. As such, the graphical captures 414 of each subset 412 comprises a portion of the full set of graphical captures 404 that were originally retrieved by the interactive timeline processing module 402.

The interactive timeline processing module 402 may then further organize the subsets 412 into sessions 416. As mentioned above, an individual session 416 is defined by a period of substantially continuous user interaction with a corresponding software application 410. Stated another way, an individual session 416 can be a period of time during which the in-focus software application does not change. As such, the number of graphical captures 414 in a subset 412 of a given session 416 can vary. That is, the volume of recorded user activity varies between different session 416. For example, one session 416 can involve a user drafting a full text document start to finish resulting in a large number of graphical captures 414 in the corresponding subset 412. In an alternative example, a user may spend a session 416 reading a fine print document with very little change in the user interface. As such, this session 416 may result in a single graphical capture 414. Furthermore, the number of session(s) 416 for a given software application 410 can also vary. For instance, a software application 410 that is frequently used by the user can result in many individual sessions 416. Conversely, a software application 410 that is used infrequently may have a comparatively smaller number of sessions 416 or even a single session 416.

Accordingly, the interactive timeline processing module 402 generates a graphical segment 418 for each of the sessions 416 (e.g., the segments 112 discussed above). The graphical segments 418 can then be compiled into an interactive timeline structure 420 by ordering the graphical segments 418 according to the time of the graphical captures 414 associated with the corresponding session 416. Specifically, the time of occurrence for a given session 416 can be defined by the time of occurrence 408 of the first graphical capture 404 of the session 416 (e.g., the earliest graphical capture 404). Finally, the interactive timeline processing module 402 can generate an interactive timeline rendering 422 for user interaction in accordance with the examples described above with respect to FIGS. 1A-3.

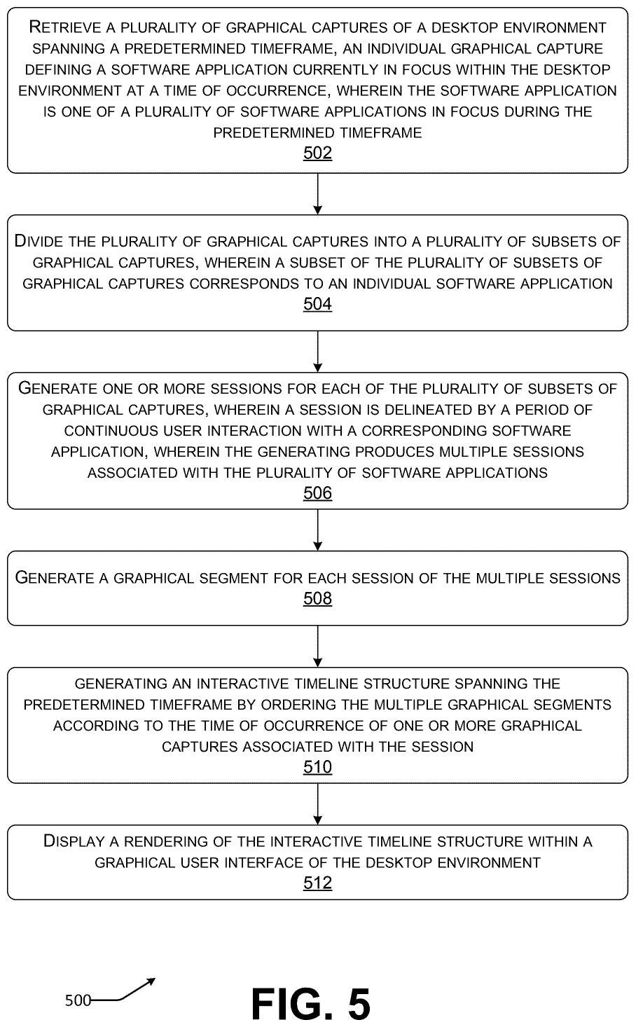

Turning now to FIG. 5, aspects of a process 500 for constructing an interactive timeline of user activity are shown and described. With respect to FIG. 5, the process 500 begins at operation 502 where a system retrieves a plurality of graphical captures of a desktop environment spanning a predetermined timeframe. An individual graphical capture defines a software application currently in focus within the desktop environment at a time of occurrence, and the software application is one of a plurality of software applications in focus during the predetermined timeframe (e.g., a week, a month). As discussed above, a graphical capture can depict a single software applications or a full desktop view having multiple software applications. In various examples, the predetermined timeframe can be user defined with consideration for privacy, storage space, performance impact, and other factors.

Then, at operation 504, the system divides the plurality of graphical captures into a plurality of subsets of graphical captures. A subset of the plurality of subsets of graphical captures corresponds to an individual software application. Stated another way, a subset of graphical captures records all of a user's interaction with a corresponding software application over the predetermined timeframe.

Next, at operation 506, the system generates one or more sessions for each of the plurality of subsets of graphical captures, wherein a session is delineated by a period of substantially continuous user interaction with a corresponding software application. The generating produces multiple sessions associated with the plurality of software applications. In various examples, each of the plurality of software applications corresponds to one or more sessions. For instance, a user opening and subsequently closing a web browser during daily use can result in multiple sessions. Conversely, the user opening a calculator application once results in only a single session.

Subsequently, at operation 508, the system generates a graphical segment for each session of the multiple sessions. As discussed above, a graphical segment represents the user activity during a corresponding session (e.g., a set of graphical captures). Consequently, the size of a given graphical segment can be calculated as a function of the number of graphical captures within the corresponding session. That is, a larger segment is utilized to intuitively display a greater associated number of graphical captures.

Then, at operation 510, the system generates an interactive timeline structure spanning the predetermined timeframe by ordering the multiple graphical segments according to the time of occurrence of one or more graphical captures associated with the session. As mentioned, the time of occurrence for a given session can be defined by the time of occurrence of the first (e.g., the earliest) graphical capture within the session. Stated another way, the time of occurrence for a given session is defined by a graphical capture indicating the beginning of the session.

Finally, at operation 512, the system displays a rendering of the interactive timeline structure within a graphical user interface of the desktop environment. In various examples, the display can be triggered by a user activation of an interface control (e.g., a button, a switch).

For ease of understanding, the process discussed in this disclosure is delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

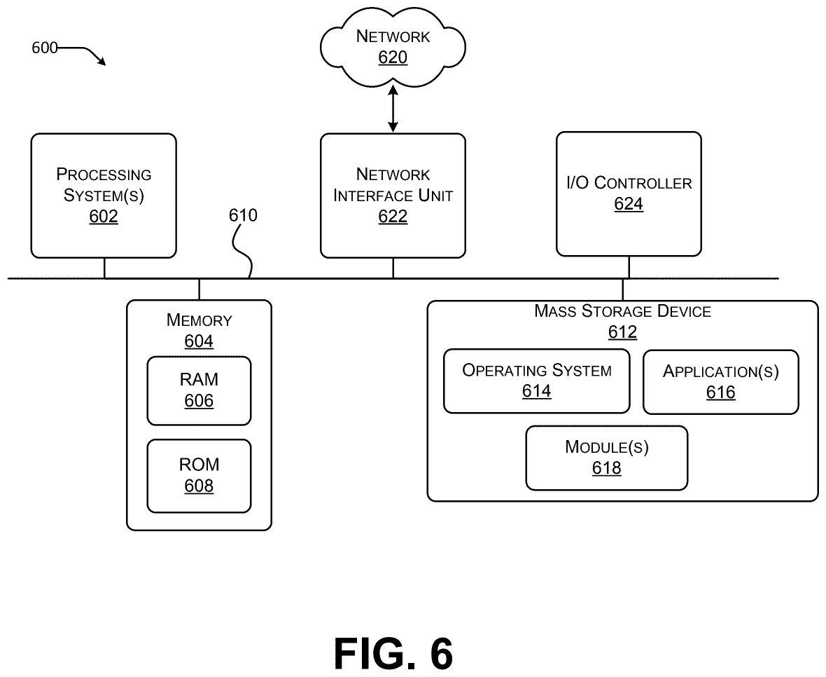

FIG. 6 shows additional details of an example computer architecture 600 for a device, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location. Moreover, the systems discussed herein can be provided as a distributed computing system such as a cloud service.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

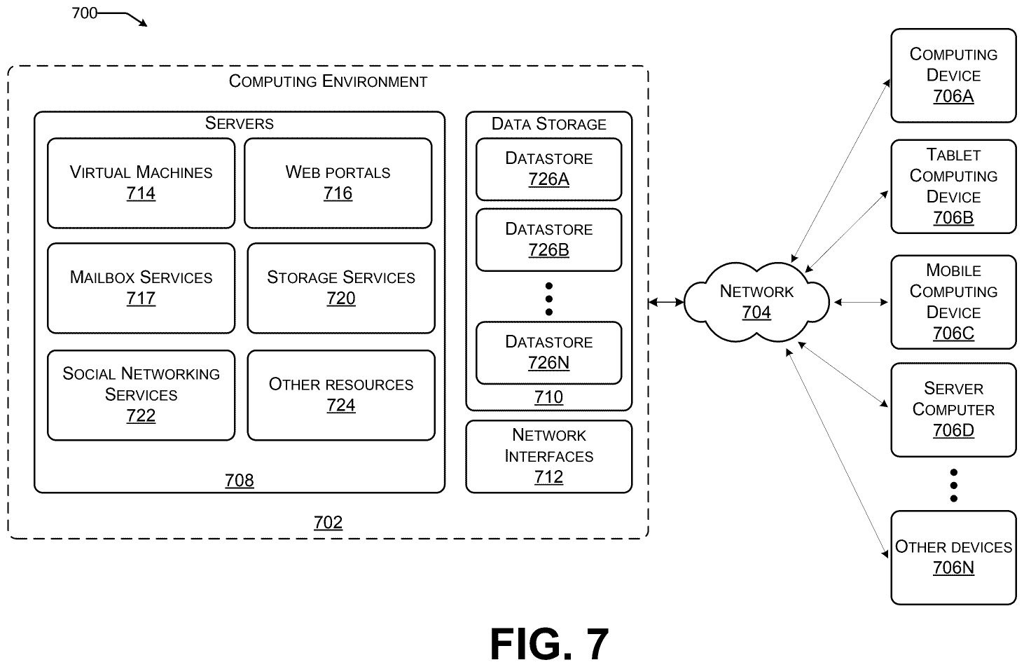

FIG. 7 depicts an illustrative distributed computing environment 700 capable of executing the software components described herein. Thus, the distributed computing environment 700 illustrated in FIG. 7 can be utilized to execute any aspects of the software components presented herein. For example, the distributed computing environment 700 can be utilized to execute aspects of the software components described herein.

Accordingly, the distributed computing environment 700 can include a computing environment 702 operating on, in communication with, or as part of the network 704. The network 704 can include various access networks. One or more client devices 706A-706N (hereinafter referred to collectively and/or generically as “computing devices 706”) can communicate with the computing environment 702 via the network 704. In one illustrated configuration, the computing devices 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of computing devices 706 can communicate with the computing environment 702.

In various examples, the computing environment 702 includes servers 708, data storage 710, and one or more network interfaces 712. The servers 708 can host various services, virtual machines, portals, and/or other resources. In the illustrated configuration, the servers 708 host virtual machines 714, Web portals 716, mailbox services 718, storage services 720, and/or social networking services 722. As shown in FIG. 7 the servers 708 also can host other services, applications, portals, and/or other resources (“other resources”) 724.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more servers configured to host data for the computing environment 700. The data storage 710 can include, host, or provide one or more real or virtual datastores 726A-726N (hereinafter referred to collectively and/or generically as “datastores 726”). The datastores 726 are configured to host data used or created by the servers 808 and/or other data. That is, the datastores 726 also can host or store web page documents, word documents, presentation documents, data structures, algorithms for execution by a recommendation engine, and/or other data utilized by any application program. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects.

The disclosure presented herein also encompasses the subject matter set forth in the following clauses.
Example Clause A, a method comprising: retrieving a plurality of graphical captures of a desktop environment spanning a predetermined timeframe, an individual graphical capture defining a software application currently in focus within the desktop environment at a time of occurrence, wherein the software application is one of a plurality of software applications in focus during the predetermined timeframe; dividing the plurality of graphical captures into a plurality of subsets of graphical captures, wherein a subset of the plurality of subsets of graphical captures corresponds to an individual software application; generating one or more sessions for each of the plurality of subsets of graphical captures, wherein a session is delineated by a period of substantially continuous user interaction with a corresponding software application, wherein the generating produces multiple sessions associated with the plurality of software applications; generating a graphical segment for each session of the multiple sessions; generating an interactive timeline structure spanning the predetermined timeframe by ordering the multiple graphical segments according to the time of occurrence of one or more graphical captures associated with the session; and displaying a rendering of the interactive timeline structure within a graphical user interface of the desktop environment.
Example Clause B, the method of Example Clause A, wherein the graphical segment is assigned a color based on the software application corresponding to the graphical captures of the subset.
Example Clause C, the method of Example Clause A or Example Clause B, further comprising: receiving a user input at a position within the rendering of the interactive timeline structure, the user input indicating a selection of a specific time of occurrence; and in response to receiving the user input, displaying a preview of a graphical capture having the specific time of occurrence associated with the position within the rendering of the interactive timeline structure.
Example Clause D, the method of Example Clause C, wherein the user input is a first user input, the method further comprising: receiving a second user input at the position within the rendering of the interactive timeline structure, the second user input indicating a confirmation for the selection of the specific time of occurrence; and in response to receiving the second user input, displaying the graphical capture having the specific time of occurrence wherein a size of the graphical capture is greater than a size of the preview of the graphical capture.
Example Clause E, the method of Example Clause D, further comprising: receiving a third user input at the graphical capture; in response to receiving the third user input, generating a restoration point data structure including the specific time of occurrence and a software application session associated with the graphical capture within the graphical user interface of the desktop environment; and providing the restoration point data structure to a session restoration module.
Example Clause F, the method of Example Clause C, wherein: the position of the user input is within a segment of the interactive timeline structure; and the rendering of the interactive timeline structure expands a size of the segment in response to the user input.
Example Clause G, the method of any one of Example Clause A through F, wherein a size of the graphical segment within the rendering of the interactive timeline structure is calculated based on a number of graphical captures comprising the subset of graphical captures associated with the corresponding session.
Example Clause H, the method of any one of Example Clause A through G, wherein the plurality of graphical captures spanning the predetermined timeframe are retrieved based on a timeline filter defining a set of software applications represented by the graphical segments of the interactive timeline.
Example Clause I, a system comprising: a processing system; and a computer-readable medium having encoded thereon computer-readable instructions that when executed by the processing system causes the system to perform operations comprising: retrieving a plurality of graphical captures of a desktop environment spanning a predetermined timeframe, an individual graphical capture defining a software application currently in focus within the desktop environment at a time of occurrence, wherein the software application is one of a plurality of software applications in focus during the predetermined timeframe; dividing the plurality of graphical captures into a plurality of subsets of graphical captures, wherein a subset of the plurality of subsets of graphical captures corresponds to an individual software application; generating one or more sessions for each of the plurality of subsets of graphical captures, wherein a session is delineated by a period of substantially continuous user interaction with a corresponding software application, wherein the generating produces multiple sessions associated with the plurality of software applications; generating a graphical segment for each session of the multiple sessions; generating an interactive timeline structure spanning the predetermined timeframe by ordering the multiple graphical segments according to the time of occurrence of one or more graphical captures associated with the session; and displaying a rendering of the interactive timeline structure within a graphical user interface of the desktop environment.
Example Clause J, the system of Example Clause I, wherein the interactive timeline structure further comprises a navigation interface element wherein activating the navigation interface element causes a changed timeframe displayed by the rendering of the interactive timeline structure.
Example Clause K, the system of Example Clause I or Example Clause J, wherein the graphical segment is assigned a color based on the software application corresponding to the graphical captures of the subset.
Example Clause L, The system of any one of Example Clause I through K, the operations further comprising: determining one or more graphical segments of the multiple graphical segments corresponds to a currently in-focus software application; and in response to determining one or more graphical segments of the multiple graphical segments corresponds to the currently in-focus software application, shading the one or more graphical segments with a color based on the currently in-focus software application.
Example Clause M, the system of any one of Example Clause I through L, the operations further comprising: receiving a user input at a position within the rendering of the interactive timeline structure, the user input indicating a selection of a specific time of occurrence; and in response to receiving the user input, displaying a preview of a graphical capture having the specific time of occurrence associated with the position within the rendering of the interactive timeline structure.
Example Clause N, the system of Example Clause M, the operations further comprising: receiving a second user input at the position within the rendering of the interactive timeline structure, the second user input indicating a confirmation for the selection of the specific time of occurrence; and in response to receiving the second user input, displaying the graphical capture having the specific time of occurrence wherein a size of the graphical capture is greater than a size of the preview of the graphical capture.
Example Clause O, the system of Example Clause N, the operations further comprising: receiving a third user input at the graphical capture; in response to receiving the third user input, generating a restoration point data structure including the specific time of occurrence and a software application session associated with the graphical capture within the graphical user interface of the desktop environment; and providing the restoration point data structure to a session restoration module.
Example Clause P, a computer-readable storage medium having encoded thereon computer-readable instructions that when executed by a system causes the system to perform operations comprising: retrieving a plurality of graphical captures of a desktop environment spanning a predetermined timeframe, an individual graphical capture defining a software application currently in focus within the desktop environment at a time of occurrence, wherein the software application is one of a plurality of software applications in focus during the predetermined timeframe; dividing the plurality of graphical captures into a plurality of subsets of graphical captures, wherein a subset of the plurality of subsets of graphical captures corresponds to an individual software application; generating one or more sessions for each of the plurality of subsets of graphical captures, wherein a session is delineated by a period of substantially continuous user interaction with a corresponding software application, wherein the generating produces multiple sessions associated with the plurality of software applications; generating a graphical segment for each session of the multiple sessions; generating an interactive timeline structure spanning the predetermined timeframe by ordering the multiple graphical segments according to the time of occurrence of one or more graphical captures associated with the session; and displaying a rendering of the interactive timeline structure within a graphical user interface of the desktop environment.
Example Clause Q, the computer-readable storage medium of Example Clause P, wherein the graphical segment is assigned a color based on the software application corresponding to the graphical captures of the subset.
Example Clause R, the computer-readable storage medium of Example Clause P or Example Clause Q, the operations further comprising: receiving a user input at a position within the rendering of the interactive timeline structure, the user input indicating a selection of a specific time of occurrence; and in response to receiving the user input, displaying a preview of a graphical capture having the specific time of occurrence associated with the position within the rendering of the interactive timeline structure.
Example Clause S, the computer-readable storage medium of Example Clause R, the operations further comprising: receiving a second user input at the position within the rendering of the interactive timeline structure, the second user input indicating a confirmation for the selection of the specific time of occurrence; and in response to receiving the second user input, displaying the graphical capture having the specific time of occurrence wherein a size of the graphical capture is greater than a size of the preview of the graphical capture.
Example Clause T, the computer-readable storage medium of Example Clause S, wherein the plurality of graphical captures spanning the predetermined timeframe are retrieved based on a timeline filter defining a set of software applications represented by the graphical segments of the interactive timeline.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different segments).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
retrieving a plurality of graphical captures of a desktop environment spanning a predetermined timeframe, an individual graphical capture defining a software application currently in focus within the desktop environment at a time of occurrence, wherein the software application is one of a plurality of software applications in focus during the predetermined timeframe;
dividing the plurality of graphical captures into a plurality of subsets of graphical captures, wherein a subset of the plurality of subsets of graphical captures corresponds to an individual software application;
generating one or more sessions for each of the plurality of subsets of graphical captures, wherein a session is delineated by a period of substantially continuous user interaction with a corresponding software application, wherein the generating produces multiple sessions associated with the plurality of software applications;
generating a graphical segment for each session of the multiple sessions;
generating an interactive timeline structure spanning the predetermined timeframe by ordering the multiple graphical segments according to the time of occurrence of one or more graphical captures associated with the session; and
displaying a rendering of the interactive timeline structure within a graphical user interface of the desktop environment.

2. The method of claim 1, wherein the graphical segment is assigned a color based on the software application corresponding to the graphical captures of the subset.

3. The method of claim 1, further comprising:
receiving a user input at a position within the rendering of the interactive timeline structure, the user input indicating a selection of a specific time of occurrence; and
in response to receiving the user input, displaying a preview of a graphical capture having the specific time of occurrence associated with the position within the rendering of the interactive timeline structure.

4. The method of claim 3, wherein the user input is a first user input, the method further comprising:
receiving a second user input at the position within the rendering of the interactive timeline structure, the second user input indicating a confirmation for the selection of the specific time of occurrence; and
in response to receiving the second user input, displaying the graphical capture having the specific time of occurrence wherein a size of the graphical capture is greater than a size of the preview of the graphical capture.

5. The method of claim 4, further comprising:
receiving a third user input at the graphical capture;
in response to receiving the third user input, generating a restoration point data structure including the specific time of occurrence and a software application session associated with the graphical capture within the graphical user interface of the desktop environment; and
providing the restoration point data structure to a session restoration module.

6. The method of claim 3, wherein:
the position of the user input is within a segment of the interactive timeline structure; and
the rendering of the interactive timeline structure expands a size of the segment in response to the user input.

7. The method of claim 1, wherein a size of the graphical segment within the rendering of the interactive timeline structure is calculated based on a number of graphical captures comprising the subset of graphical captures associated with the corresponding session.

8. The method of claim 1, wherein the plurality of graphical captures spanning the predetermined timeframe are retrieved based on a timeline filter defining a set of software applications represented by the graphical segments of the interactive timeline.

9. A system comprising:
a processing system; and
a computer-readable medium having encoded thereon computer-readable instructions that when executed by the processing system causes the system to perform operations comprising:
retrieving a plurality of graphical captures of a desktop environment spanning a predetermined timeframe, an individual graphical capture defining a software application currently in focus within the desktop environment at a time of occurrence, wherein the software application is one of a plurality of software applications in focus during the predetermined timeframe;
dividing the plurality of graphical captures into a plurality of subsets of graphical captures, wherein a subset of the plurality of subsets of graphical captures corresponds to an individual software application;
generating one or more sessions for each of the plurality of subsets of graphical captures, wherein a session is delineated by a period of substantially continuous user interaction with a corresponding software application, wherein the generating produces multiple sessions associated with the plurality of software applications;
generating a graphical segment for each session of the multiple sessions;
generating an interactive timeline structure spanning the predetermined timeframe by ordering the multiple graphical segments according to the time of occurrence of one or more graphical captures associated with the session; and
displaying a rendering of the interactive timeline structure within a graphical user interface of the desktop environment.

10. The system of claim 9, wherein the interactive timeline structure further comprises a navigation interface element wherein activating the navigation interface element causes a changed timeframe displayed by the rendering of the interactive timeline structure.

11. The system of claim 9, wherein the graphical segment is assigned a color based on the software application corresponding to the graphical captures of the subset.

12. The system of claim 9, the operations further comprising:
determining one or more graphical segments of the multiple graphical segments corresponds to a currently in-focus software application; and
in response to determining one or more graphical segments of the multiple graphical segments corresponds to the currently in-focus software application, shading the one or more graphical segments with a color based on the currently in-focus software application.

13. The system of claim 9, the operations further comprising:
receiving a user input at a position within the rendering of the interactive timeline structure, the user input indicating a selection of a specific time of occurrence; and
in response to receiving the user input, displaying a preview of a graphical capture having the specific time of occurrence associated with the position within the rendering of the interactive timeline structure.

14. The system of claim 13, the operations further comprising:
receiving a second user input at the position within the rendering of the interactive timeline structure, the second user input indicating a confirmation for the selection of the specific time of occurrence; and
in response to receiving the second user input, displaying the graphical capture having the specific time of occurrence wherein a size of the graphical capture is greater than a size of the preview of the graphical capture.

15. The system of claim 14, the operations further comprising:
receiving a third user input at the graphical capture;
in response to receiving the third user input, generating a restoration point data structure including the specific time of occurrence and a software application session associated with the graphical capture within the graphical user interface of the desktop environment; and
providing the restoration point data structure to a session restoration module.

16. A computer-readable storage medium having encoded thereon computer-readable instructions that when executed by a system causes the system to perform operations comprising:
retrieving a plurality of graphical captures of a desktop environment spanning a predetermined timeframe, an individual graphical capture defining a software application currently in focus within the desktop environment at a time of occurrence, wherein the software application is one of a plurality of software applications in focus during the predetermined timeframe;
dividing the plurality of graphical captures into a plurality of subsets of graphical captures, wherein a subset of the plurality of subsets of graphical captures corresponds to an individual software application;
generating one or more sessions for each of the plurality of subsets of graphical captures, wherein a session is delineated by a period of substantially continuous user interaction with a corresponding software application, wherein the generating produces multiple sessions associated with the plurality of software applications;
generating a graphical segment for each session of the multiple sessions;
generating an interactive timeline structure spanning the predetermined timeframe by ordering the multiple graphical segments according to the time of occurrence of one or more graphical captures associated with the session; and
displaying a rendering of the interactive timeline structure within a graphical user interface of the desktop environment.

17. The computer-readable storage medium of claim 16, wherein the graphical segment is assigned a color based on the software application corresponding to the graphical captures of the subset.

18. The computer-readable storage medium of claim 16, the operations further comprising:
receiving a user input at a position within the rendering of the interactive timeline structure, the user input indicating a selection of a specific time of occurrence; and
in response to receiving the user input, displaying a preview of a graphical capture having the specific time of occurrence associated with the position within the rendering of the interactive timeline structure.

19. The computer-readable storage medium of claim 18, the operations further comprising:
receiving a second user input at the position within the rendering of the interactive timeline structure, the second user input indicating a confirmation for the selection of the specific time of occurrence; and
in response to receiving the second user input, displaying the graphical capture having the specific time of occurrence wherein a size of the graphical capture is greater than a size of the preview of the graphical capture.

20. The computer-readable storage medium of claim 19, wherein the plurality of graphical captures spanning the predetermined timeframe are retrieved based on a timeline filter defining a set of software applications represented by the graphical segments of the interactive timeline.
